(19) United States
(12) Patent Application Publication
(10) Pub. No.: US 2005/0279002 A1
(43) Pub. Date: Dec. 22, 2005

(54) Transparent plant tag

(76) Inventor: Alice Doyle, Cottage Grove, OR (US)

Correspondence Address: Wolff & Samson PC, One Boland Drive, West Orange, NJ, 07052, US

(21) Appl. No.: 10/869,319

(22) Filed: Jun. 16, 2004

(51) Int. Cl. G09F 23/00

(52) U.S. Cl. 40/645

(57) ABSTRACT

A transparent plant tag is provided. The tag can be used with any desired plant, including potted plants and flowers. The tag and allows for viewing of a plant, through the tag, when the tag is positioned near a plant. The tag comprises a transparent upper portion having indicia thereon providing information related to the plant, and a bottom portion for insertion into soil to position the tag. The indicia on the upper portion can include an image of the mature plant or flower.

### BACKGROUND OF THE INVENTION

1. Field of the Invention

The present invention relates to plant tags. More specifically, the present invention relates to a transparent plant tag that contains information thereon.

2. Related Art

Identification tags for potted plants are well known in the art. Such tags are used to convey information about the plant and often identify the type (i.e., genus and species) of a plant, and include a picture of the mature plant or flower. Additionally, plant tags may also include information relating to care for the plant, as well as pruning and other related information. Typically, plant tags are manufactured from a lightweight plastic material.

A drawback with existing plant tags is that they are opaque, and as such, obscure viewing of the plant when the tag is placed in the pot. Further, existing plant tags can be aesthetically unpleasing, and can detract from the overall appearance of a potted plant when the tag is positioned in the pot. Yet, the information on the tag is important to potential customers.

Accordingly, what would be desirable, but has not yet been provided, is a plant tag that is aesthetically pleasing, allows easy viewing of a potted plant, and provides information and/or a picture of the mature plant or flower.

### SUMMARY OF THE INVENTION

The present invention relates to a transparent plant tag. The tag can be used with any desired plant, including potted plants and flowers. The tag includes an upper transparent portion that allows one to see the plant, through the tag, when the tag is positioned near the plant. The upper portion can include indicia thereon providing information related to the plant. The indicia on the upper portion can include an image of the mature plant or flower. A bottom portion of the tag is configured for insertion into a plant pot to position the tag.

The present invention also provides a method of allowing a person to view and plant and information about the plant. The method comprises the steps of providing a transparent plant tag; providing information on the transparent plant tag; placing the transparent plant tag into a plant pot; and allowing a person to view the plant through the transparent plant tag.

### BRIEF DESCRIPTION OF THE DRAWINGS

Other important objects and features of the invention will be apparent from the following Detailed Description of the Invention taken in connection with the accompanying drawings in which:

FIG. 1 is a perspective view of the plant tag of the present invention.

FIG. 2 is a side view of the plant tag of the present invention.

FIG. 3 is a cross-sectional view of the bottom portion of the plant tag of the present invention, taken along the line 3-3 of FIG. 1.

FIG. 4 is a front view of the plant tag of the present invention.

FIG. 5 is a rear view of the plant tag of the present invention.

FIG. 6 is a front view of the plant tag of the present invention, wherein the tag is positioned in a potted plant and the plant is viewable through the tag.

### DETAILED DESCRIPTION OF THE INVENTION

The present invention relates to a transparent plant tag that can be used with any desired plant, including potted plants and flowers. By the term “plant,” it is meant any plant, flower, shrub, tree, etc., that is positioned in a pot for sale. The tag includes an upper portion that is transparent, and allows one to view a plant, through the tag, when the tag is positioned near the plant. The upper portion includes indicia thereon that provides information related to the plant. The indicia on the upper portion can include an image of the mature plant or flower. A bottom portion of the tag is configured for insertion into a pot to position the tag.

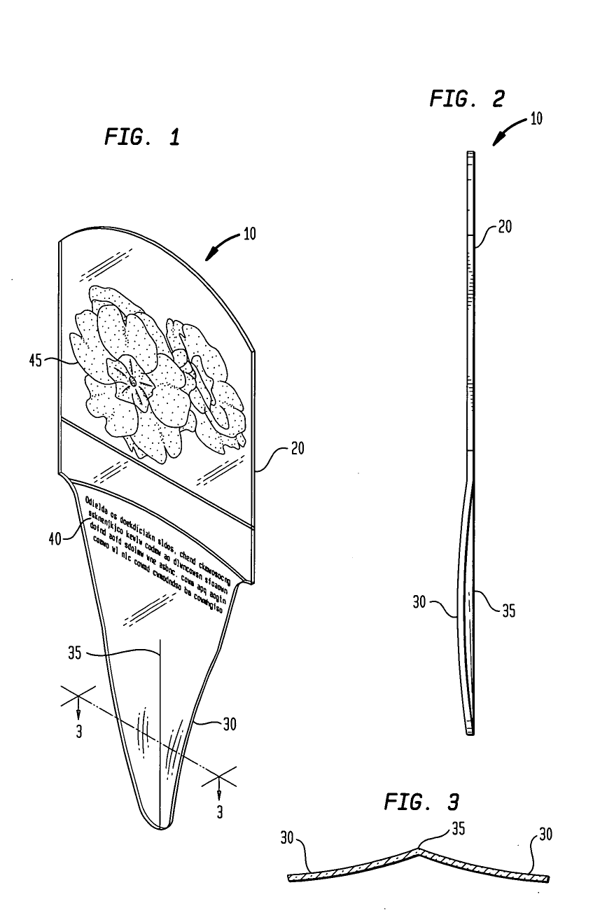

FIG. 1 is a perspective view of the transparent plant tag of the present invention, indicated generally at 10. The tag 10 comprises an upper portion 20 and a lower portion 30. The upper portion 20 is transparent and includes indicia 45, which provides information relating to a plant. The indicia 45 could be an image of the plant or flower, as well as textual information about the plant or flower. The upper portion 20 is generally rectangular in shape with an arched upper edge, but of course, any desired shape could be provided.

The transparent upper portion 20 allows for easy viewing of a plant, through the tag, when the tag is positioned near the plant. The lower portion 30 includes a tapered end to allow easy insertion and positioning of the tag 10 into soil, or into a tag slot in a plant or flower pot. The lower portion 30 could be transparent or opaque. A kink 35 can optionally be provided on the lower portion 30 to provide added rigidity for the lower portion 30 and to ease insertion of the lower portion 30 into soil. Optionally, an upper area of the lower portion 30 could include information 40 relating to a plant. This information could relate to plant care information and/or information relating to the genus and species of the plant, etc., as is known in the art. Such information could be provided at any desired location on the tag, e.g., on the upper portion 20 and/or the lower portion 30, using any desired font or style.

The tag 10 is manufactured from a transparent plastic material similar to materials used in the art to manufacture conventional opaque plant tags, such as a polymer or other similar material. Similarly, techniques used in connection with printing images and information on opaque tags can be utilized with the transparent tag of the present invention. Numerous tags 10 could be formed from a sheet of material.

FIG. 2 is a side view of the tag 10 of the present invention. The upper and lower portions 20, 30 are transparent to allow easy viewing therethrough. Further, transparency prevents the tag 10 from detracting from the overall aesthetic appearance of a plant when the tag 10 is placed near the plant. The kink 35 prevents the lower portion 30 from flexing, so that the tag 10 can be easily inserted into soil.

FIG. 3 is a cross-sectional view of the bottom portion of the plant tag 10 of the present invention, taken along the line 3-3 of FIG. 1. The kink 35 extends along the longitudinal axis of the tag 10 and along the lower portion 30, so that an angle is formed in the lower portion 30. Any desired angle could be provided.

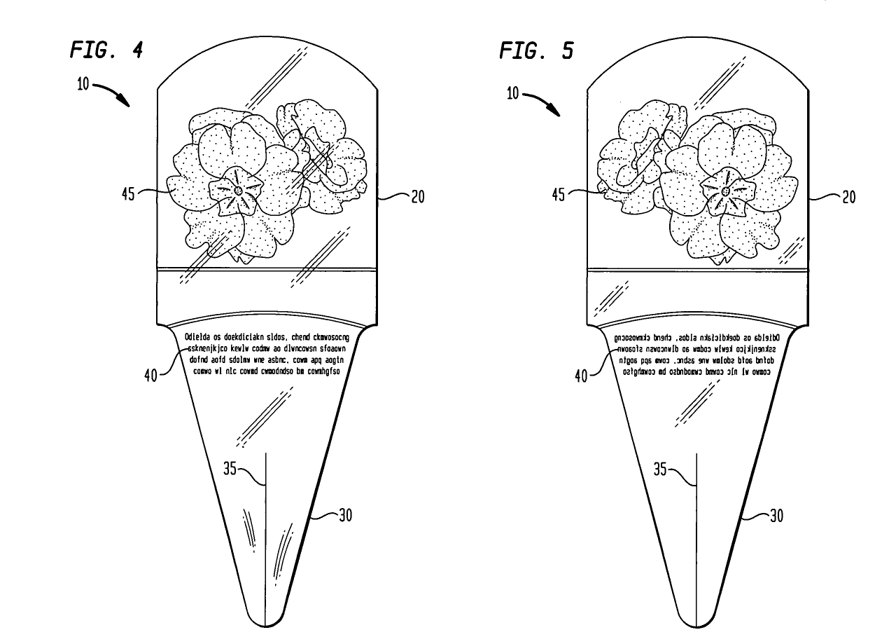

FIGS. 4 and 5 are front and rear views, respectively, of the plant tag 10 of the present invention. The indicia 45 provides information about a plant or flower. The plant or flower to be viewed through the transparent tag.

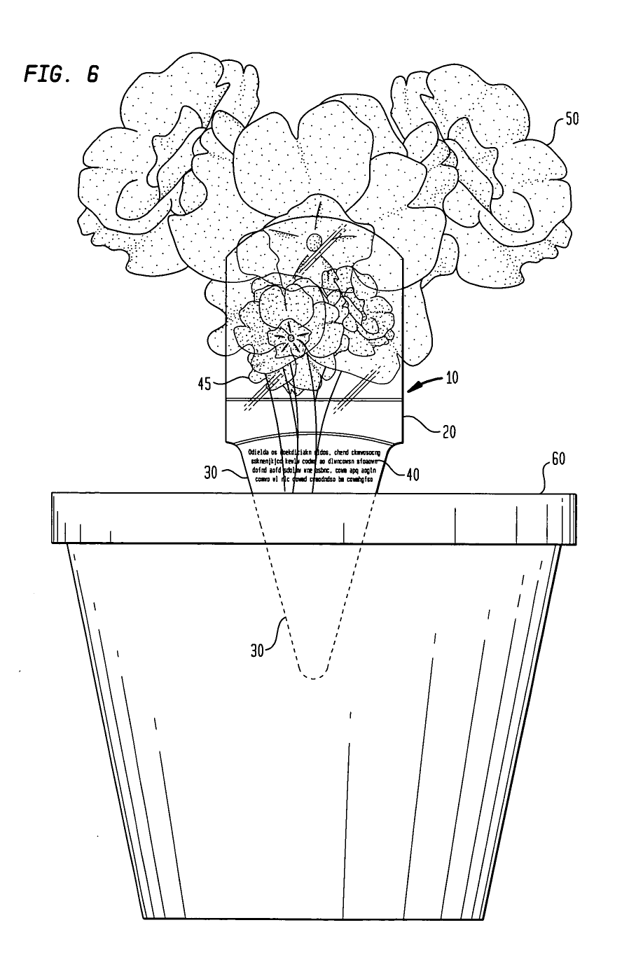

FIG. 6 is a front view of the plant tag 10 of the present invention, wherein the tag is positioned in a potted plant and the plant is viewable through the tag. The plant 50 could be any plant, shrub, flower, or the like, and is planted in pot 60. The lower portion 30 of the tag 10 is positioned into the soil of the pot 60. Information 40 and indicia 45 on the tag 10 are visible to a prospective purchaser of the plant 50. The plant 50 is visible through the upper portion 20 of the tag 10. Thus, the tag 10 provides useful information about the plant 50, but does not detract from the overall appearance of the plant 50.

Having thus described the invention in detail, it is to be understood that the foregoing description is not intended to limit the spirit and scope thereof. What is desired to be protected by Letters Patent is set forth in the appended claims.

1. A transparent plant tag comprising:
a transparent upper portion having indicia thereon relating to a plant; and
a lower portion interconnected with the transparent upper portion, the lower portion insertable into a plant pot.

2. The tag of claim 1, wherein the indicia comprises an image of the plant.

3. The tag of claim 1, wherein the indicia comprises information about the plant.

4. The tag of claim 2, wherein the indicia comprises information about the plant.

5. The tag of claim 1, wherein the lower portion is transparent.

6. The tag of claim 1, further comprising information relating to the plant on the lower portion of the tag.

7. A method of allowing a person to view and plant and information about the plant, comprising:
providing a transparent plant tag;
providing information on the transparent plant tag;
placing the transparent plant tag into a plant pot; and
allowing a person to view the plant through the transparent plant tag.

8. The method of claim 7, wherein the step of providing information on the transparent plant tag comprises providing an image of the plant on the transparent plant tag.
